(19) United States
(12) Patent Application Publication
(10) Pub. No.: US 2015/0061174 A1
(43) Pub. Date: Mar. 5, 2015

(54) SOUND ISOLATION UNIT AND PRODUCTION METHOD THEREOF

(71) Applicant: VOLVO CAR CORPORATION, Gothenburg (SE)

(72) Inventors: Mikael HOLMSTROM, Onsala (SE); Frederik LINDEN, Varberg (SE)

(21) Appl. No.: 14/461,672

(22) Filed: Aug. 18, 2014

(30) Foreign Application Priority Data
Aug. 28, 2013 (EP) 13181937.7

(51) Int. Cl. F02B 77/13; C08J 9/228; F02B 39/00

(52) U.S. Cl. CPC F02B 77/13; F02B 39/00; C08J 9/228; C08J 2201/02; C08J 2300/24; C08J 2375/04
USPC 264/46.6; 181/294

(57) ABSTRACT

A supercharger system for a vehicle engine comprises a supercharger and a sound isolation unit at least partly surrounding the supercharger. The sound isolation unit comprises an inner layer facing the supercharger, a sound barrier layer facing away from the supercharger and a core there between. All three layers are made from polyurethane but with different densities. Furthermore, the core comprises an open cell structure for sound absorption.

### CROSS-REFERENCE TO RELATED APPLICATIONS

This application claims foreign priority benefits under 35 U.S.C. §119(a)-(d) to European patent application number EP 13181937.7, filed Aug. 28, 2013, which is incorporated by reference in its entirety.

### TECHNICAL FIELD

The disclosure relates to a supercharger system for a vehicle engine. The system comprises a supercharger and a sound isolation unit at least partly surrounding the supercharger unit. Further, a method for manufacturing such sound isolation unit is also disclosed.

### BACKGROUND

It is known to use superchargers in vehicle engines to increase performance of the engine during certain conditions, for example when aiding quick revving of the engine when the engine is running on few rotations per minute (RPM) and a turbocharger consequently being essentially disabled due to low gas flow. It is known that the supercharger produces a very high noise level of 150-160 dB. Current legislation in a number of countries has an upper limit of 70 dB.

It is known to use isolation material for the supercharger, for example in EP1783345, but none which has the desired parameters of low cost, three dimensional geometry, low weight, heat durability, small volume and the desired sound dampening.

### SUMMARY

An object of the disclosure is to remedy the problems described with prior art.

A supercharger system for a vehicle engine comprises a supercharger and a sound isolation unit at least partly surrounding the supercharger unit. The sound isolation unit comprises an inner layer facing the supercharger, a sound barrier layer facing away from the supercharger and a core there between. All three layers are made from polyurethane but with different densities. The core comprises an open cell structure for sound absorption.

The inner layer is thin enough to allow sound from the supercharger to pass the layer for transport into the open cell structure. The open cell structure comprises a number of intertwined channels, i.e., channels that are interconnected in a non-structured way. When the sound has passed the inner layer the sound is lead into the core and the many intertwined channels. Should the sound or a weakened portion of the sound pass the core, the sound is reflected against the sound barrier layer back into the core. In the core, the sound is lead through the material and the different channels and thus starts breaking down into different directions. When the sound in the different channels meet in the channels and channel junctions, the sound starts to break down further. The breaking down of the sound is due to many factors.

When sound travels through a medium, its intensity diminishes with distance. In idealized materials, sound pressure (signal amplitude) is only reduced by the spreading of the wave. Natural materials, however, all produce an effect which further weakens the sound. This further weakening results from scattering and absorption. Scattering is the reflection of the sound in directions other than its original direction of propagation. Absorption is the conversion of the sound energy to other forms of energy. The combined effect of scattering and absorption is called attenuation. Ultrasonic attenuation is the decay rate of the wave as it propagates through material. The channels and the material in the core thus attenuate the sound.

The sound isolation unit may be subject to liquid contamination, for example water splashing during rain etc., but it is not desired if water is stored in the sound isolation unit due to for example weight reasons. Furthermore, some channels may be thin enough to exert capillary forces on a liquid and thus draw water into the channel. Therefore, the inner layer should prevent water or other liquids from entering the channels why the inner channel could be liquid impermeable but sound permeable.

In order to allow for the sound to pass the inner layer, the inner layer has a maximum thickness of maximum 0.2 mm and a density of 800-1000 g/L.

In order to prevent the sound from passing right through the sound isolation unit, the sound barrier layer has a thickness of 1-2 mm and a density of 800-1000 g/L. Experiments have shown good results with a thickness of 1.5 mm and a density of 1000 g/L. It should be noted that the sound barrier layer together with the core cannot totally mute the sound, but only bring the sound level from the supercharger down from 150-160 dB to under the legislative value of 70 dB.

In order to further hinder sound from exiting the sound isolation unit, the sound barrier layer could comprises a metal sheet or another sheet with high density and weight per surface unit. A suitable sheet has proven to be galvanized sheet metal with a density normally of 7750-8050 kg/m³ with a thickness of 0.7 mm, but the range 0.5-0.7 mm has proven to be a suitable range. The sheet preferably covers only a portion of the isolation unit and may be allocated to a portion of the supercharger emitting a certain frequency or a focused strong sound. The heavier and denser the sheet is the better it prevents low frequency noise. A supercharger typically generates sound in the frequency range of 700-4000 Hz.

The core may comprise a three dimensional structure with one or a plurality of cavities for increased sound absorption area.

It has been proven that the material in the core structure advantageously has a thickness of 5-30 mm and a density of 70-230 g/L.

When polyurethane foam is created a resin cures under formation of gas which creates bubbles within the cured foam. The open cell structure of the core is made from crushing the gas bubbles within the core created during curing of the polyurethane.

A method for manufacturing a sound isolation unit for a supercharger in a vehicle engine may comprise the following steps:
polyurethane is sprayed into a first mould portion and then cured to form the sound barrier layer;
polyurethane is injected onto the cured sound barrier layer in the mould;
a second mould portion is pressed into the polyurethane to a predetermined distance from the first mould portion;
the polyurethane expands under creation of gas bubbles within the core and then cures within the mould;
the inner layer is created during the expansion due to pressure against the second mould portion; and
the cured sound isolation unit is either mechanically compressed or put under an under pressure (e.g., a pressure less than atmospheric pressure) for breaking the walls between the bubbles to create the open cell structure.

The sprayed polyurethane may have different composition reactants than the core, which eliminates the bubbles and gives a homogeneous layer suitable as sound barrier layer. The reactants may be such that the sprayed resin cures essentially immediately without swelling.

A different method for manufacturing a sound isolation unit for a supercharger in a vehicle engine may comprise the following steps:
polyurethane is injected into a first mould portion;
a second mould portion is pressed into the polyurethane to a predetermined distance from the first mould portion;
the polyurethane expands under creation of gas bubbles within the core and then cures within the mould;
the first mould portion is brought to a first predetermined temperature to form the sound barrier layer in the mould;
the second mould portion is brought into a second predetermined temperature to form the inner layer; and
the cured and cooled down sound isolation unit is either mechanically compressed or put under an under pressure for breaking the walls between the bubbles to create the open cell structure.

For both methods, the crushing of the bubbles and the open cell structure gives 10-20% better sound absorption than if the core would have been untreated.

The thickness of the layer is dependent on the temperature. The first temperature is therefore higher than the second temperature and may vary dependent on desired thickness. The temperature also eliminates the bubbles in the material which gives a homogeneous layer suitable as sound barrier layer.

For both methods, the following features of the sound isolation unit may be applicable.

The inner layer is made water impermeable and sound permeable and is made to have a maximum thickness of maximum 0.2 mm and a density of 800-1000 g/L.

The sound barrier layer is made to have a thickness of 1-2 mm and a density of 800-1000 g/L, preferably 1.5 mm.

A metal sheet may be positioned in the first mould portion before the creation of the sound barrier layer to be incorporated into the sound barrier layer.

The material in the core structure is made to have a thickness of 5-30 mm and a density of 70-230 g/L.

The second mould portion may comprise protrusions that gives the core a three dimensional structure with one or a plurality of cavities for increased sound absorption area. The more cavities, the more walls are created and the walls increase the area.

Polyurethanes are not novel as such, but have been known for many years, but it is the combination of the identified layers and open cell structure that has the stated benefits. Depending on a number of parameters, the polyurethane resin may have different composition. Such parameters are, for example, porosity of the core, density of the layers, the behaviour of the resin during its formation to foam, i.e., the curing. The material choice in the finished sound isolation product, and therefore the resin choice, is depending on which peak frequencies of the sound that is desired to eliminate, heat durability, etc.

Polyurethanes are in the class of compounds called reaction polymers, which include epoxies, unsaturated polyesters, and phenolics. Polyurethanes are produced by reacting an isocyanate containing two or more isocyanate groups per molecule (R—(N═C═O)n≧2) with a polyol containing on average two or more hydroxy groups per molecule (R′—(OH)n≧2), in the presence of a catalyst.

The properties of a polyurethane are greatly influenced by the types of isocyanates and polyols used to make it. Long, flexible segments, contributed by the polyol, give soft, elastic polymer. High amounts of crosslinking give tough or rigid polymers. Long chains and low crosslinking give a polymer that is very stretchy, short chains with lots of crosslinks produce a hard polymer while long chains and intermediate crosslinking give a polymer useful for making foam. The crosslinking present in polyurethanes means that the polymer consists of a three-dimensional network and molecular weight is very high. In some respects a piece of polyurethane can be regarded as one giant molecule. One consequence of this is that typical polyurethanes do not soften or melt when they are heated, hence they are thermosetting polymers. The choices available for the isocyanates and polyols, in addition to other additives and processing conditions allow polyurethanes to have the very wide range of properties that make them such widely used polymers.

Isocyanates are very reactive materials. This makes them useful in making polymers but also requires special care in handling and use. The aromatic isocyanates, diphenylmethane diisocyanate (MDI) or toluene diisocyanate (TDI) are more reactive than aliphatic isocyanates, such as hexamethylene diisocyanate (HDI) or isophorone diisocyanate (IPDI). Most of the isocyanates are difunctional, that is they have exactly two isocyanate groups per molecule. An important exception to this is polymeric diphenylmethane diisocyanate, which is a mixture of molecules with two-, three-, and four- or more isocyanate groups. In cases like this the material has an average functionality greater than two, commonly 2.7. Isocyanates with functionality greater than two act as crosslinking sites as mentioned in the previous paragraph.

Polyols are polymers in their own right and have on average two or more hydroxyl groups per molecule. Polyether polyols are mostly made by polymerizing ethylene oxide and propylene oxide. Polyester polyols are made similarly to polyester polymers. The polyols used to make polyurethanes are not “pure” compounds since they are often mixtures of similar molecules with different molecular weights and mixtures of molecules that contain different numbers of hydroxyl groups, which is why the “average functionality” is often mentioned. Despite them being complex mixtures, industrial grade polyols have their composition sufficiently well controlled to produce polyurethanes having consistent properties. As mentioned earlier, it is the length of the polyol chain and the functionality that contribute much to the properties of the final polymer. Polyols used to make rigid polyurethanes have molecular weights in the hundreds, while those used to make flexible polyurethanes have molecular weights up to ten thousand or more.

The polymerization reaction makes a polymer containing the urethane linkage, —RNHCOOR′— and is catalyzed by tertiary amines, such as 1,4-diazabicyclo octane (also called DABCO or TEDA), and metallic compounds, such as dibutyltin dilaurate or bismuth octanoate. This is often referred to as the gellation reaction or simply gelling.

If water is present in the reaction mixture (it is often added intentionally to make foams), the isocyanate reacts with water to form a urea linkage and carbon dioxide gas and the resulting polymer contains both urethane and urea linkages. This reaction is referred to as the blowing reaction and is catalyzed by tertiary amines like bis-(2-dimethylaminoethyl)ether.

A third reaction, particularly important in making insulating rigid foams is the isocyanate trimerization reaction, which is catalyzed by potassium octoate, for example.

One of the most desirable attributes of polyurethanes is their ability to be turned into foam. Making a foam requires the formation of a gas at the same time as the urethane polymerization (gellation) is occurring. The gas can be carbon dioxide, either generated by reacting isocyanate with water, or added as a gas or produced by boiling volatile liquids. In the latter case heat generated by the polymerization causes the liquids to vaporize. The liquids can be HFC-245fa (1,1,1,3,3-pentafluoropropane) and HFC-134a (1,1,1,2-tetrafluoroethane), and hydrocarbons such as n-pentane.

When water is used to produce the gas, care must be taken to use the right combination of catalysts to achieve the proper balance between gellation and blowing. The reaction to generate carbon dioxide involves water molecule reacting with an isocyanate first forming an unstable carbamic acid, which then decomposes into carbon dioxide and an amine. The amine reacts with more isocyanate to give a substituted urea. Water has a very low molecular weight, so even though the weight percent of water may be small, the molar proportion of water may be high and considerable amounts of urea produced. The urea is not very soluble in the reaction mixture and tends to form separate “hard segment” phases consisting mostly of polyurea. The concentration and organization of these polyurea phases can have a significant impact on the properties of the polyurethane foam.

High-density microcellular foams can be formed without the addition of blowing agents by mechanically frothing or nucleating the polyol component prior to use.

Surfactants are used in polyurethane foams to emulsify the liquid components, regulate cell size, and stabilize the cell structure to prevent collapse and surface defects. Rigid foam surfactants are designed to produce very fine cells and a very high closed cell content. Flexible foam surfactants are designed to stabilize the reaction mass while at the same time maximizing open cell content to prevent the foam from shrinking

An even more rigid foam can be made with the use of specialty trimerization catalysts which create cyclic structures within the foam matrix, giving a harder, more thermally stable structure, designated as polyisocyanurate foams. Such properties are desired in rigid foam products used in the construction sector.

Careful control of viscoelastic properties—by modifying the catalysts and polyols used—can lead to memory foam, which is much softer at skin temperature than at room temperature.

Foams can be either “closed cell”, where most of the original bubbles or cells remain intact, or “open cell”, where the bubbles have broken but the edges of the bubbles are stiff enough to retain their shape. Open cell foams feel soft and allow air to flow through so they are comfortable when used in seat cushions or mattresses. Closed cell rigid foams are used as thermal insulation, for example in refrigerators.

Microcellular foams are tough elastomeric materials used in coverings of car steering wheels or shoe soles.

The main ingredients to make a polyurethane are isocyanates and polyols. Other materials are added to help processing the polymer or to change the properties of the polymer.

Isocyanates used to make polyurethane must have two or more isocyanate groups on each molecule. The most commonly used isocyanates are the aromatic diisocyantes, toluene diisocyanate (TDI) and methylene diphenyl diisocyanate, MDI.

TDI and MDI are generally less expensive and more reactive than other isocyanates. Industrial grade TDI and MDI are mixtures of isomers and MDI often contains polymeric materials. They are used to make flexible foam (for example slabstock foam for mattresses or molded foams for car seats), rigid foam (for example insulating foam in refrigerators) elastomers (shoe soles, for example), and so on. The isocyanates may be modified by partially reacting them with polyols or introducing some other materials to reduce volatility (and hence toxicity) of the isocyanates, decrease their freezing points to make handling easier or to improve the properties of the final polymers.

Aliphatic and cycloaliphatic isocyanates are used in smaller volumes, most often in coatings and other applications where color and transparency are important since polyurethanes made with aromatic isocyanates tend to darken on exposure to light. The most important aliphatic and cycloaliphatic isocyanates are 1,6-hexamethylene diisocyanate (HDI), 1-isocyanato-3-isocyanatomethyl-3,5,5-trimethyl-cyclohexane (isophorone diisocyanate, IPDI), and 4,4′-diisocyanato dicyclohexylmethane, (H12MDI or hydrogenated MDI).

Polyols can be polyether polyols, which are made by the reaction of epoxides with an active hydrogen containing starter compounds, or polyester polyols, which are made by the polycondensation of multifunctional carboxylic acids and hydroxyl compounds. They can be further classified according to their end use. Higher molecular weight polyols (molecular weights from 2,000 to 10,000) are used to make more flexible polyurethanes while lower molecular weight polyols make more rigid products.

Polyols for flexible applications use low functionality initiators such as dipropylene glycol (f=2), glycerine (f=3) or a sorbitol/water solution (f=2.75). Polyols for rigid applications use high functionality initiators such as sucrose (f=8), sorbitol (f=6), toluenediamine (f=4), and Mannich bases (f=4). Propylene oxide and/or ethylene oxide is added to the initiators until the desired molecular weight is achieved. The order of addition and the amounts of each oxide affect many polyol properties, such as compatibility, water-solubility, and reactivity. Polyols made with only propylene oxide are terminated with secondary hydroxyl groups and are less reactive than polyols capped with ethylene oxide, which contain a higher percentage of primary hydroxyl groups. Graft polyols (also called filled polyols or polymer polyols) contain finely dispersed styrene-acrylonitrile, acrylonitrile, or polyurea (PHD) polymer solids chemically grafted to a high molecular weight polyether backbone. They are used to increase the load-bearing properties of low-density high-resiliency (HR) foam, as well as add toughness to microcellular foams and cast elastomers. Initiators such as ethylenediamine and triethanolamine are used to make low molecular weight rigid foam polyols that have built-in catalytic activity due to the presence of nitrogen atoms in the backbone. A special class of polyether polyols, poly(tetramethylene ether) glycols, which are made by polymerizing tetrahydrofuran, are used in high performance coating, wetting and elastomer applications.

Conventional polyester polyols are based on virgin raw materials and are manufactured by the direct polyesterification of high-purity diacids and glycols, such as adipic acid and 1,4-butanediol. Polyester polyols are usually more expensive and more viscous than polyether polyols, but they make polyurethanes with better solvent, abrasion, and cut resistance. Other polyester polyols are based on reclaimed raw materials. They are manufactured by transesterification (glycolysis) of recycled poly(ethyleneterephthalate) (PET) or dimethylterephthalate (DMT) distillation bottoms with glycols such as diethylene glycol. These low molecular weight, aromatic polyester polyols are used in rigid foam, and bring low cost and excellent flammability characteristics to polyisocyanurate (PIR) boardstock and polyurethane spray foam insulation.

Specialty polyols include polycarbonate polyols, polycaprolactone polyols, polybutadiene polyols, and polysulfide polyols. The materials are used in elastomer, sealant, and adhesive applications that require superior weatherability, and resistance to chemical and environmental attack. Natural oil polyols derived from castor oil and other vegetable oils are used to make elastomers, flexible bunstock, and flexible molded foam. Copolymerizing chlorotrifluoroethylene or tetrafluoro ethylene with vinyl ethers containing hydroxyalkyl vinyl ether produces fluorinated (FEVE) polyols. Two component fluorinated polyurethane prepared by reacting FEVE fluorinated polyols with polyisocyanate have been applied for make ambient cure paint/coating. Since fluorinated polyurethanes contain high percentage of fluorine-carbon bond which is the strongest bond among all chemical bonds. Fluorinated polyurethanes have excellent resistance to UV, acids, alkali, salts, chemicals, solvents, weathering, corrosion, fungi and microbial attack. These have become the first choice for high performance coating/paints.

Chain extenders (f=2) and cross linkers (f=3 or greater) are low molecular weight hydroxyl and amine terminated compounds that play an important role in the polymer morphology of polyurethane fibers, elastomers, adhesives, and certain integral skin and microcellular foams. The elastomeric properties of these materials are derived from the phase separation of the hard and soft copolymer segments of the polymer, such that the urethane hard segment domains serve as cross-links between the amorphous polyether (or polyester) soft segment domains. This phase separation occurs because the mainly non-polar, low melting soft segments are incompatible with the polar, high melting hard segments. The soft segments, which are formed from high molecular weight polyols, are mobile and are normally present in coiled formation, while the hard segments, which are formed from the isocyanate and chain extenders, are stiff and immobile. Because the hard segments are covalently coupled to the soft segments, they inhibit plastic flow of the polymer chains, thus creating elastomeric resiliency. Upon mechanical deformation, a portion of the soft segments are stressed by uncoiling, and the hard segments become aligned in the stress direction. This reorientation of the hard segments and consequent powerful hydrogen bonding contributes to high tensile strength, elongation, and tear resistance values. The choice of chain extender also determines flexural, heat, and chemical resistance properties. The most important chain extenders are ethylene glycol, 1,4-butanediol (1,4-BDO or BDO), 1,6-hexanediol, cyclohexane dimethanol and hydroquinone bis(2-hydroxyethyl) ether (HQEE). All of these glycols form polyurethanes that phase separate well and form well defined hard segment domains, and are melt processable. They are all suitable for thermoplastic polyurethanes with the exception of ethylene glycol, since its derived bis-phenyl urethane undergoes unfavorable degradation at high hard segment levels. Diethanolamine and triethanolamine are used in flex molded foams to build firmness and add catalytic activity. Diethyltoluenediamine is used extensively in RIM, and in polyurethane and polyurea elastomer formulations.

Polyurethane catalysts can be classified into two broad categories, amine compounds and metal complexes. Traditional amine catalysts have been tertiary amines such as triethylenediamine (TEDA, 1,4-diazabicyclo[2.2.2]octane or DABCO), dimethylcyclohexylamine (DMCHA), and dimethylethanolamine (DMEA). Tertiary amine catalysts are selected based on whether they drive the urethane (polyol+isocyanate, or gel) reaction, the urea (water+isocyanate, or blow) reaction, or the isocyanate trimerization reaction (e.g., using potassium acetate, to form isocyanurate ring structure). Catalysts that contain a hydroxyl group or secondary amine, which react into the polymer matrix, can replace traditional catalysts thereby reducing the amount of amine that can come out of the polymer.

Metallic compounds based on mercury, lead, tin, bismuth, and zinc are used as polyurethane catalysts. Mercury carboxylates, are particularly effective catalysts for polyurethane elastomer, coating and sealant applications, since they are very highly selective towards the polyol+isocyanate reaction, but they are toxic. Bismuth and zinc carboxylates have been used as alternatives. Alkyl tin carboxylates, oxides and mercaptides oxides are used in all types of polyurethane applications. Tin mercaptides are used in formulations that contain water, as tin carboxylates are susceptible to hydrolysis.

Surfactants are used to modify the characteristics of both foam and non-foam polyurethane polymers. They take the form of polydimethylsiloxane-polyoxyalkylene block copolymers, silicone oils, nonylphenol ethoxylates, and other organic compounds. In foams, they are used to emulsify the liquid components, regulate cell size, and stabilize the cell structure to prevent collapse and sub-surface voids. In non-foam applications they are used as air release and anti-foaming agents, as wetting agents, and are used to eliminate surface defects such as pin holes, orange peel, and sink marks.

Polyurethanes are produced by mixing two or more liquid streams. The isocyanate is usually added by itself and the polyol stream is usually more complex, containing catalysts, surfactants, blowing agents and so on. The two components are referred to as a polyurethane system, or simply a system. The isocyanate is commonly referred to in North America as the ‘A-side’ or just the ‘iso’. The blend of polyols and other additives is commonly referred to as the ‘B-side’ or as the ‘poly’. This mixture might also be called a ‘resin’ or ‘resin blend’. In Europe the meanings for ‘A-side’ and ‘B-side’ are reversed. Resin blend additives may include chain extenders, cross linkers, surfactants, flame retardants, blowing agents, pigments, and fillers. Polyurethane can be made in a variety of densities and hardnesses by varying the isocyanate, polyol or additives.

### BRIEF DESCRIPTION OF THE DRAWINGS

Embodiments according to the disclosure will be described below with reference to the following drawings, in which:

FIG. 1 schematically shows a sound isolation unit and a supercharger unit;

FIG. 2 schematically shows a mould process for an isolation unit;

FIG. 3 schematically shows a sound isolation unit, and where; and

FIG. 4 shows a flow chart of a method for manufacturing a sound isolation unit.

### DETAILED DESCRIPTION

As required, detailed embodiments are disclosed herein. However, it is to be understood that the disclosed embodiments are merely exemplary and that various and alternative forms may be employed. The figures are not necessarily to scale. Some features may be exaggerated or minimized to show details of particular components. Therefore, specific structural and functional details disclosed herein are not to be interpreted as limiting, but merely as a representative basis for teaching one skilled in the art.

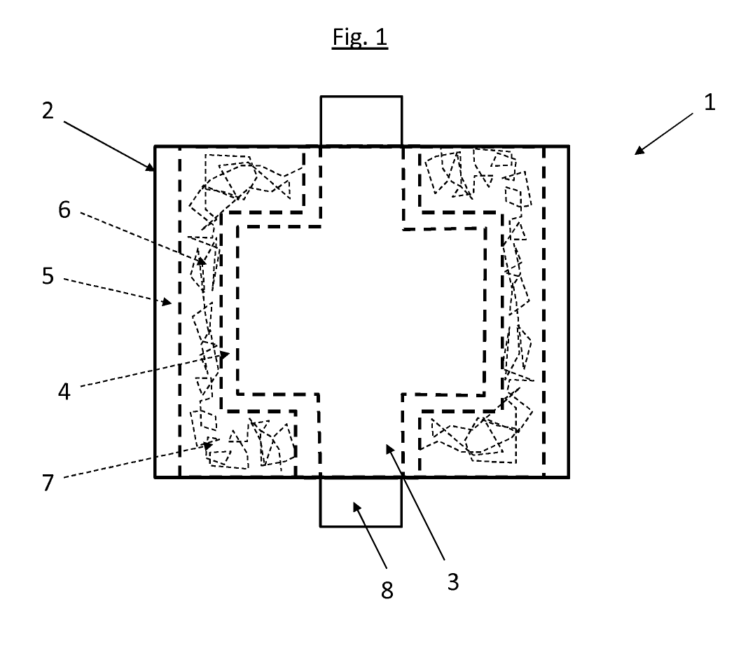

FIG. 1 schematically shows a supercharger system 1 comprising a sound isolation unit 2 and a supercharger unit 3. The sound isolation unit 2 comprises an inner layer 4 facing the supercharger 3, a sound barrier layer 5 facing away from the supercharger 3 and a core 6 there between. All three layers 4, 5, 6 are made from polyurethane but with different densities. The core 6 comprises an open cell structure 7 for sound absorption.

In FIG. 1 the sound isolation unit 2 surrounds the supercharger unit 3 but allows for pipes 8 and cables to extend through the sound isolation unit 2. The sound isolation unit 2 does not have to completely surround the supercharger unit 3, but may cover only a part. The supercharger unit 3 may have identified spots that transmit sound to the surrounding more than other spots on the supercharger 3. It is then important to cover at least those spots with the sound isolation unit 2. The material in the sound isolation unit 2 may thus vary in thickness due to such spots. One benefit with varied thickness is less weight and volume of the sound isolation unit.

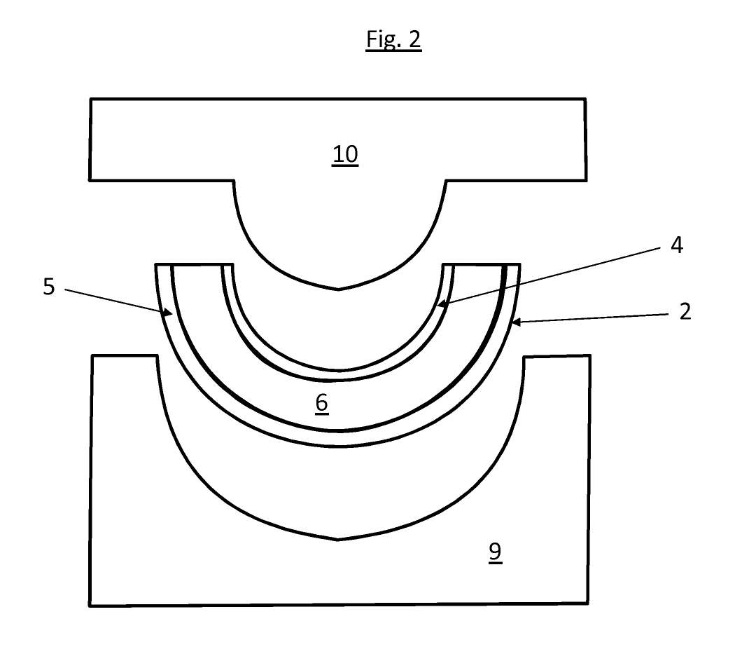

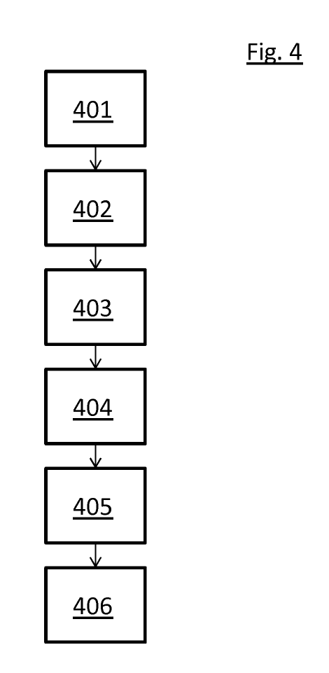

FIG. 2 schematically shows a mould process for an isolation unit. The mould comprises a first mould portion 9 and a second mould portion 10 arranged opposite the first mould portion at a predetermined distance from each other to create a space for the polyurethane for the isolation unit. In FIG. 2 the first mould portion 9, the second mould portion 10 and the isolation unit are shown in an exploded view after curing of the polyurethane resin. There are different techniques to mould/cast the isolation unit 2, which will be described with reference to FIG. 4.

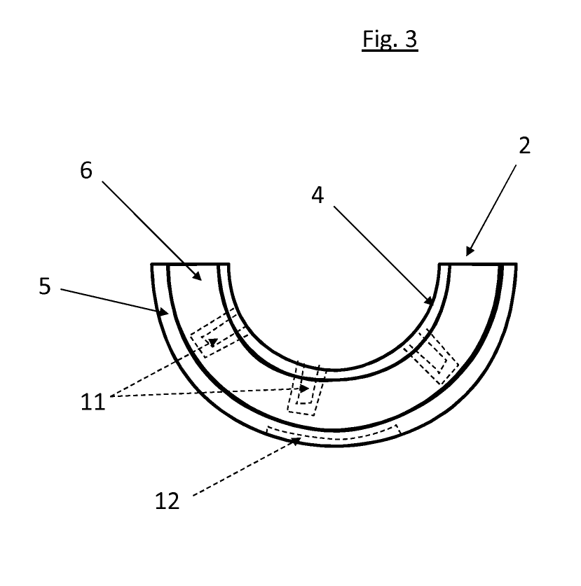

FIG. 3 schematically shows a sound isolation unit 2 according to FIGS. 1 and 2. The sound isolation unit in FIG. 3 is half a complete surrounding sound isolation unit and may be used as it is covering one side of the supercharger 3, but may also be one of two halves that put together completely surround the supercharger 3 as in FIG. 1. As mentioned before, the sound isolation unit may come in different shapes and forms and may surround the supercharger completely or only partly. In the latter example, the form need not be in the form of one half, but may be any other suitable fraction greater or smaller than a half.

In FIG. 3 the isolation unit comprises cavities 11 that increase the sound absorbing area of the material building the core. The second mould portion in FIG. 2 then has corresponding protrusions. FIG. 3 also shows that a reinforced sheet 12 has been positioned in the sound barrier layer 5 at a predetermined position in order to reinforce the sound barrier layer 5 to further hinder the sound from exiting the isolation unit.

FIG. 4 shows a flow chart of a method for manufacturing a sound isolation unit.

The flow chart will be used in connection with two different casting techniques.

### Technique 1

### Box 401

polyurethane is sprayed into a first mould portion and then cured to form the sound barrier layer
if a reinforcement sheet should be positioned in the sound barrier layer, it should be positioned in the first mould portion before or in conjunction with the spraying.

### Box 402

polyurethane is injected onto the cured sound barrier layer in the mould

### Box 403

a second mould portion is pressed into the polyurethane to a predetermined distance from the first mould portion

### Box 404

the polyurethane expands under creation of gas bubbles within the core and then cures within the mould

### Box 405

the inner layer is created during the expansion due to pressure against the second mould portion

### Box 406

the cured sound isolation unit is either mechanically compressed or put under an under pressure for breaking the walls between the bubbles to create the open cell structure.

The sprayed polyurethane may have different composition reactants than the core, which eliminates the bubbles and gives a homogeneous layer suitable as sound barrier layer. The reactants may be such that the sprayed resin cures essentially immediately without swelling.

### Technique 2

### Box 401

polyurethane is injected into a first mould portion
if a reinforcement sheet should be positioned in the sound barrier layer, it should be positioned in the first mould portion before or in conjunction with the injection

### Box 402

a second mould portion is pressed into the polyurethane to a predetermined distance from the first mould portion

### Box 403

the polyurethane expands under creation of gas bubbles within the core and then cures within the mould

### Box 404

the first mould portion is brought to a first predetermined temperature to form the sound barrier layer in the mould

### Box 405

the second mould portion is brought into a second predetermined temperature to form the inner layer

### Box 406

the cured and cooled down sound isolation unit is either mechanically compressed or put under an under pressure for breaking the walls between the bubbles to create the open cell structure.

The thickness of the layer is dependent on the temperature. The first temperature is therefore higher than the second temperature and may vary dependent on desired thickness. The temperature also eliminates the bubbles in the material which gives a homogeneous layer suitable as sound barrier layer.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A supercharger system for a vehicle engine, the system comprising:
a supercharger; and
a sound isolation unit at least partly surrounding the supercharger, the sound isolation unit comprising an inner layer facing the supercharger, a sound barrier layer facing away from the supercharger and a core between the inner layer and the sound barrier layer, wherein all three layers are made from polyurethane but with different densities, and wherein the core comprises an open cell structure for sound absorption.

2. The system according to claim 1 wherein the inner layer is liquid impermeable and sound permeable.

3. The system according to claim 1 wherein the inner layer has a maximum thickness of 0.2 mm and a density of 800-1000 g/L.

4. The system according to claim 1 wherein the sound barrier layer has a thickness of 1-2 mm and a density of 800-1000 g/L.

5. The system according to claim 4 wherein the sound barrier layer has a thickness of 1.5 mm.

6. The system according to claim 1 wherein the sound barrier layer further comprises a metal sheet.

7. The system according to claim 1 wherein the core comprises a three dimensional structure with one or a plurality of cavities for increased sound absorption area.

8. The system according to claim 1 wherein the core has a thickness of 5-30 mm and a density of 70-230 g/L.

9. The system according to claim 1 wherein the open cell structure of the core is made from crushing gas bubbles within the core created during curing of the polyurethane.

10. A method for manufacturing a sound isolation unit for a supercharger in a vehicle engine such that the sound isolation unit comprises an inner layer configured to face the supercharger, a sound barrier layer configured to face away from the supercharger and a core between the inner layer and the sound barrier layer, and such that the core has an open cell structure for sound absorption, the method comprising:
spraying polyurethane into a first mould portion of a mould and allowing the polyurethane to cure to form the sound barrier layer;
injecting polyurethane onto the cured sound barrier layer in the first mould portion;
pressing a second mould portion of the mould into the injected polyurethane to a predetermined distance from the first mould portion;
allowing the polyurethane to expand under creation of gas bubbles, and curing the expanded polyurethane within the mould;
forming the inner layer during expansion of the polyurethane due to pressure against the second mould portion; and
mechanically compressing the cured sound isolation unit or putting the cured sound isolation unit under an under pressure to break walls between the bubbles to form the open cell structure;
wherein the method is performed such that all three layers are made from polyurethane but have different densities.

11. The method according to claim 10 wherein the inner layer is made liquid impermeable and sound permeable, and is made to have a maximum thickness of 0.2 mm and a density of 800-1000 g/L.

12. The method according to claim 10 wherein the sound barrier layer is made to have a thickness of 1-2 mm and a density of 800-1000 g/L.

13. The method according to claim 10 wherein a metal sheet is positioned in the first mould portion before the creation of the sound barrier layer to be incorporated into the sound barrier layer.

14. The method according to claim 10 wherein the core is made to have a thickness of 5-30 mm and a density of 70-230 g/L.

15. A method for manufacturing a sound isolation unit for a supercharger in a vehicle engine such that the sound isolation unit comprises an inner layer configured to face the supercharger, a sound barrier layer configured to face away from the supercharger and a core between the inner layer and the sound barrier layer, and such that the core has an open cell structure for sound absorption, the method comprising:
injecting polyurethane into a first mould portion of a mould;
pressing a second mould portion of the mould into the polyurethane to a predetermined distance from the first mould portion;
allowing the polyurethane to expand under creation of gas bubbles, and curing the expanded polyurethane within the mould;
bringing the first mould portion to a first predetermined temperature to form the sound barrier layer in the mould;
bringing the second mould portion to a second predetermined temperature to form the inner layer; and
mechanically compressing the cured and cooled down sound isolation unit or putting the cured and cooled down sound isolation unit under an under pressure to break walls between the bubbles to form the open cell structure;
wherein the method is performed such that all three layers are made from polyurethane but have different densities.

16. The method according to claim 15 wherein the inner layer is made liquid impermeable and sound permeable, and is made to have a maximum thickness of maximum 0.2 mm and a density of 800-1000 g/L.

17. The method according to claim 15 wherein the sound barrier layer is made to have a thickness of 1-2 mm and a density of 800-1000 g/L.

18. The method according to claim 15 wherein a metal sheet is positioned in the first mould portion before the creation of the sound barrier layer to be incorporated into the sound barrier layer.

19. The method according to claim 15 wherein the core is made to have a thickness of 5-30 mm and a density of 70-230 g/L.
